(19) United States
(12) Patent Application Publication
(10) Pub. No.: US 2013/0263411 A1
(43) Pub. Date: Oct. 10, 2013

(54) SEAT BELT ADAPTER

(71) Applicant: Christian Jagodzinski, Miami Beach, FL (US)

(72) Inventor: Christian Jagodzinski, Miami Beach, FL (US)

(21) Appl. No.: 13/440,752

(22) Filed: Apr. 5, 2012

(51) Int. Cl. B60R 22/00; B23P 11/00

(52) U.S. Cl. 24/633; 24/629; 29/428

(57) ABSTRACT

A system and method is provided whereby an article being a seat belt adapter is provided with a first male attachment and a second female receiving cavity in which said article is used with a vehicle seat belt system.

### BACKGROUND OF THE INVENTION

### Field of the Invention

Most modern automobiles and motor vehicles have many electronic systems that have developed over the years. One such system is the automatic seat belt warning indicator. This system typically sounds an audio alarm when the vehicle is operated and a seat belt has not been inserted into a seat belt receiving device. There are however, instances where one may wish to operate a motor vehicle and not utilize a seat belt. In these situations, operating the motor vehicle without utilizing the seat belt produces a continual audio alarm. One such example, without limitation would be moving cars around parking on a private property.

Therefore, a need exists for a device that will disable a seat belt alarm in a vehicle.

### SUMMARY OF THE INVENTION

The present invention provides a device having a conventional seat belt male connector that is constructed and arranged to be inserted into a conventional seat belt receiver. The device of the present invention is further constructed and arranged to have a seat belt receiving cavity such that the article of the present invention can be secured into position in an automobile seat belt receiver and as desired can receive a conventional seat belt connecting buckle therein.

In one embodiment, the present invention is an article being a seat belt adapter for use in a motor vehicle seat belt system comprising:

a central body;

a male seat belt buckle attachment on one end of said main body;

a seat belt receiving cavity on an opposite end of said main body;

and seat belt securing mechanism contained therein.

The central body has incorporated therewith, a release mechanism for releasing a vehicle male seat belt connector from attachment to said main body through said receiving cavity. The release mechanism acts in concert with the internal securing mechanism for locking a seat belt into a closed and secured configuration.

Also contemplated is a method of using a seat belt adapter comprising the steps of:

providing an adapter according to the present invention; attaching said male buckle attachment to a vehicle seat belt receiving device.

In one embodiment, the attaching of the adapter deactivates a vehicle seat belt connection alarm. This can be done such that the seat belt connection alarm found in most vehicles is deactivated without a seat belt being worn by the user.

The method further comprises attaching a male vehicle seat belt connector to said main body by placing said male vehicle seat belt attachment into said receiving cavity of said article main body and actuating attachment by engaging said seat belt securing mechanism contained therein.

Some seat belt beepers and alarms are so deafening that a person can't even start the car in a garage without having the seatbelt closed first. If a person needs to do maintenance on the car, and simply drive it 10 feet to the front of the garage, the driver constantly have to fasten/unfasten the seat belt without purpose.

This often leads to people closing the seatbelt on an empty seat, and simply sitting on the closed seatbelt—very dangerous, as there is no way to properly fasten the seat belt around the body anymore once sat on.

Also contemplated is the device of the present invention making the buckle longer, for instance when using a baby seat. The problem with buckling up baby seats is that a user always has to reach very far to the other side to find the receiver buckle. with this “extension” inserted, car seat attachment becomes a significantly easier.

### BRIEF DESCRIPTION OF THE SEVERAL VIEWS OF THE DRAWING

FIG. 1 is a separated view showing the article of the present invention in an environment of use.

FIG. 2 shows the article of the present invention in a connected configuration.

FIG. 3 is a top view of the article of the present invention.

FIG. 4 is a front view of the article of the present invention.

FIG. 5 is a side view of the article of the present invention.

### DETAILED DESCRIPTION OF THE PREFERRED EMBODIMENT

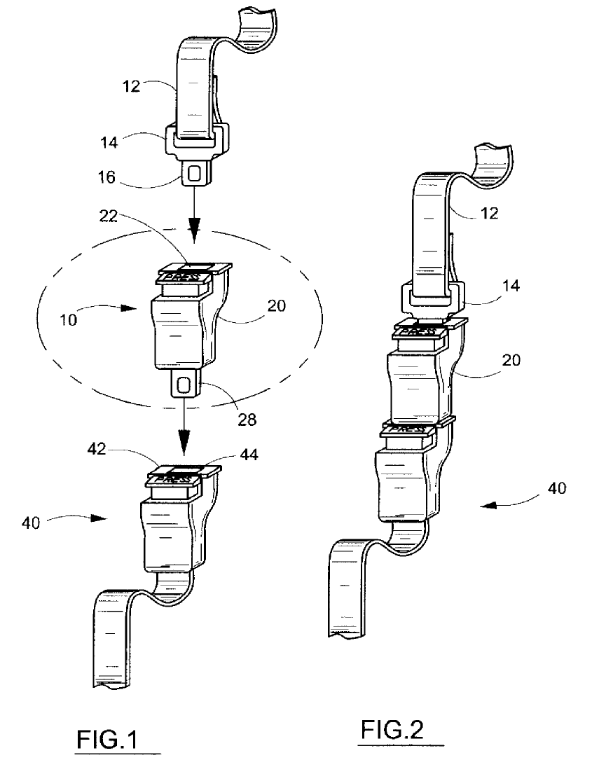

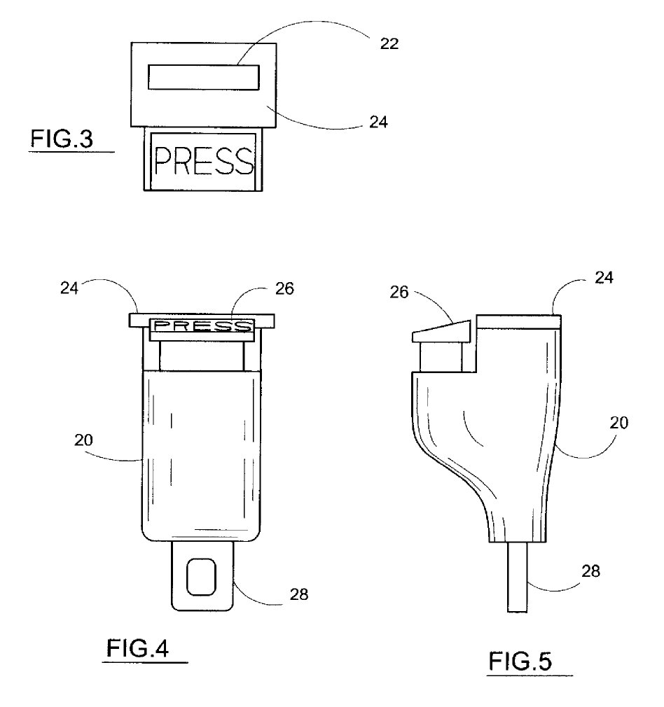

The present invention provides an article and system for use with automobile seat belts. Article 10 is constructed and arranged to receive a conventional male automobile seat belt buckle 16 that is connected on buckle support 14. Buckle support 14, as is known in the art has connected thereto automobile seat belt 12. As is generally known, an automobile has a seat belt receiver 40. Seat belt receiver 40, come in many different configurations, and the figures are for illustrative purposes only. As is generally understood, seat belt receiver platform 42 defines a seat belt buckle receiving cavity 44 and a seat belt buckle is inserted therein. In the present invention, instead of inserting seat belt buckle 16 into seat belt buckle receiving cavity 44, assembly buckle 28 is inserted into cavity 44. This is generally shown in the progression from FIG. 1 to FIG. 2. The article 10 of the present invention has a main body 20. On one end of main body 20 is article fastening buckle 28. On the opposite end from article fastening buckle 28 is article platform 20 that defines article buckle receiving cavity 22. When article buckle 28 is inserted into seat belt receiving cavity 44, as is generally known in automobiles that are manufactured today, the seat belt sensor is deactivated. At this point a user can choose to use a convention automobile seat belt 12 or to not use automobile seat belt 12. In the case of non-use,because buckle 28 is inserted into cavity 44, the seat belt warning devices on automobiles will not be activated.

As is generally understood the article 10 of the present invention utilizes conventional fastening and unfastening mechanisms that are known in the art. For example, when automobile seat belt buckle 16 is inserted into the apparatus cavity 22 internal attachment may be by any mechanism as is commonly known in the art for attaching and securing seat belt buckles. The same is true whereby apparatus buckle 28 inserts into automobile supplied seat belt connector 40 by inserting buckle 28 into cavity 44, and ultimately securing into a fastened position in manners that are known in the art. The securing is in accordance with established safety standards such that a buckle secures into position and is not released until a releasing mechanism is activated. Article 10 has on it a convention spring loaded release mechanism whereby release is activated by pressing platform 24 such that internal mechanisms (not shown) release a buckle that is secured within article 10. The present invention further encompasses a method for disabling automobile seat belt sensors whereby buckle 28 of article 10 is inserted into cavity 44 of seat belt receiver 40. In this use, a seat belt is not required to be fastened and secured, yet the seat belt warning device of an automobile is deactivated.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

I claim:

1. An article being a seat belt adapter for use in a motor vehicle seat belt system comprising:
a central body;
a male seat belt buckle attachment on one end of said main body;
a seat belt receiving cavity on an opposite end of said main body;
and seat belt securing mechanism contained therein.

2. The article of claim 1 wherein said central body has incorporated therewith, a release mechanism for releasing a vehicle male seat belt connector from attachment to said main body through said receiving cavity.

3. A method of using a seat belt adapter comprising the steps of:
providing an adapter according to claim 1;
attaching said male buckle attachment to a vehicle seat belt receiving device.

4. The method of claim 3 wherein said attaching deactivates a vehicle seat belt connection alarm.

5. The method of claim 3 further comprising attaching a male vehicle seat belt connector to said main body by placing said male vehicle seat belt attachment into said receiving cavity of said article main body and actuating attachment by engaging said seat belt securing mechanism contained therein.
